(19) United States
(12) Patent Application Publication
(10) Pub. No.: US 2013/0321748 A1
(43) Pub. Date: Dec. 5, 2013

(54) PSVA Liquid Crystal Display Panel, Liquid Crystal Display Device and Liquid Crystal Display Device

(71) Applicant: Chih-tsung Kang, Shenzhen (CN)

(72) Inventor: Chih-tsung Kang, Shenzhen (CN)

(73) Assignee: SHENZHEN CHINA STAR OPTOELECTRONICS TECHNOLOGY CO. LTD., Shenzhen (CN)

(21) Appl. No.: 13/574,611

(22) PCT Filed: Jun. 11, 2012
(86) PCT No.: PCT/CN12/76709

§ 371 Date: Jul. 22, 2012

(30) Foreign Application Priority Data
Jun. 5, 2012 (CN) 201210183265.0

(51) Int. Cl. G02F 1/1335

(52) U.S. Cl. CPC G02F 1/133528
USPC 349/103

(57) ABSTRACT

The present invention provides a PSVA liquid crystal display panel, a liquid crystal display panel and a liquid crystal display device. The liquid crystal display panel includes upper and lower substrates, disposed oppositely, with liquid crystal sandwiched between upper and lower substrates; liquid crystal molecules in liquid crystal vertically aligned; surfaces of upper and lower substrates having upper and lower polarizers respectively, optical axes of upper and lower polarizers perpendicular to each other; surface of upper polarizer closer to lower polarizer having upper quarter waveplate, surface of lower polarizer closer to upper polarizer having a lower quarter waveplate; wherein slow axis of upper quarter waveplate and slow axis of lower quarter waveplate forming 45° angle with optical axes of upper and lower polarizers respectively, slow axes of upper and lower quarter waveplates perpendicular to each other so as to ensure high transmittance and response speed.

### BACKGROUND OF THE INVENTION

1. Field of the Invention

The present invention relates to the field of liquid crystal displaying techniques, and in particular to a PSVA liquid crystal display panel, liquid crystal display panel and liquid crystal display device.

2. The Related Arts

In liquid crystal displaying techniques, general vertical alignment cell (VA cell) design must regulate tilt direction (direction parallel to axis of polarizer) of liquid crystal molecules through pixel Indium Tin Oxides (ITO) pattern specification design. By regulating tilt direction of liquid crystal molecules through pixel ITO pattern specification design, phenomenon of slow response caused by error in tilt direction of liquid crystal molecules because of voltage switching during liquid crystal molecule driving process.

The pixel ITO pattern design must form stripe electrode areas on ITO electrode to regulate electrical field distribution. The angle between stripe electrode area and polarizer horizontal optical axis is 45°, wherein when designing pixel ITO pattern, the denser the stripe electrode area is, the more accurate distribution of electrical field is guaranteed and faster response time of liquid crystal molecules is ensured. However, the area between stripe electrode areas has no electrical field to rotate the liquid crystal molecules in that area, which results in reduced transmittance rate of the light in the area.

Polymer stabilization vertical alignment (PSVA) and patterned vertical alignment (PVA) liquid crystal display devices belong to VA liquid crystal display device category. For example, refer to FIG. 1-FIG. 4. For pixel ITO pattern (as shown in FIG. 1) of PSVA liquid crystal display device or pixel ITO pattern (as shown in FIG. 2) of PVA liquid crystal display device, if the ITO pitch is too large, i.e., as shown in FIG. 1, area between two adjacent stripe electrode areas 100, or as shown in FIG. 2, area between adjacent first stripe electrode area 200 and second stripe electrode area 300, dynamic response speed of liquid crystal molecules will decrease. In combination with over driving, the response speed will go under shooting (as shown in FIG. 3) or over shooting (as shown in FIG. 4) phenomenon. The appearance of the phenomenon is because of the following: in VA liquid crystal display device, for the liquid crystal molecules in driving behavior, due to liquid crystal molecules corresponding to stripe electrode area are affected by upper and lower electrode electrical field and flux effect to cause response time delay, the rotation angle of liquid crystal molecules cannot keep 45° with the polarizer optical axis, and requires more time to realize angular rotation to achieve the correct state of forming 45° with the polarizer optical axis.

Thus, it is desired; to have a solution to maintaining higher light transmittance and improving liquid crystal response speed.

### SUMMARY OF THE INVENTION

The technical issue to be addressed by the present invention is to provide a PSVA liquid crystal display panel, liquid crystal display panel, and liquid crystal display device to ensure higher light transmittance as well as improve liquid crystal molecules response speed.

The present invention provides a PSVA liquid crystal display panel, which comprises: upper substrate and lower substrate, disposed oppositely, with liquid crystal sandwiched between the upper substrate and the lower substrate; liquid crystal molecules in liquid crystal being vertically aligned; surface of upper substrate being disposed with upper polarizer, surface of lower substrate being disposed with lower polarizer, and optical axes of upper polarizer and lower polarizer being perpendicular to each other; a surface of upper polarizer closer to lower polarizer being disposed with upper quarter waveplate, a surface of lower polarizer closer to upper polarizer being disposed with lower quarter waveplate; wherein slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other; a surface of lower quarter waveplate closer to upper quarter waveplate being disposed with pixel electrode, pixel electrode comprising a plurality of stripe electrode areas disposed in parallel separately, gap between adjacent stripe electrode areas being larger than or equal to 10 micro-meters (um); in addition, stripe electrode area forming 45° angle with optical axis of lower polarizer, gaps between any two adjacent stripe electrode areas being the same or different.

According to a preferred embodiment of the present invention, the pixel electrode further comprises data line area, scan line area and active area, gap between adjacent stripe electrode areas of data line area and/or scan line area is smaller than gap between adjacent stripe electrode areas of active area.

The present invention provides a liquid crystal display panel, which comprises: upper substrate and lower substrate, disposed oppositely, with liquid crystal sandwiched between the upper substrate and the lower substrate; liquid crystal molecules in liquid crystal being vertically aligned; surface of upper substrate being disposed with upper polarizer, surface of lower substrate being disposed with lower polarizer, and optical axes of upper polarizer and lower polarizer being perpendicular to each other; a surface of upper polarizer closer to lower polarizer being disposed with upper quarter waveplate, a surface of lower polarizer closer to upper polarizer being disposed with lower quarter waveplate; wherein slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other.

According to a preferred embodiment of the present invention, the liquid crystal display panel is a PSVA display panel; a surface of lower quarter waveplate closer to upper quarter waveplate is disposed with pixel electrode, pixel electrode comprises a plurality of stripe electrode areas disposed in parallel separately, gap between adjacent stripe electrode areas is larger than or equal to 10 micro-meters (um).

According to a preferred embodiment of the present invention, stripe electrode area forms 45° angle with optical axis of lower polarizer.

According to a preferred embodiment of the present invention, gaps between any two adjacent stripe electrode areas are the same or different.

According to a preferred embodiment of the present invention, the pixel electrode further comprises data line area, scan line area and active area, gap between adjacent stripe electrode areas of data line area and/or scan line area is smaller than gap between adjacent stripe electrode areas of active area.

According to a preferred embodiment of the present invention, the liquid crystal display panel is a PVA display panel; a surface of upper quarter waveplate closer to lower quarter waveplate is disposed with color filter layer, a surface of lower quarter waveplate closer to upper quarter waveplate is disposed with thin film transistor layer, wherein a surface of color filter layer closer to thin film transistor layer is disposed with common electrode, a surface of thin film transistor layer closer to color filter layer is disposed with pixel electrode correspondingly; pixel electrode comprises a plurality of first stripe electrode areas disposed in parallel separately, common electrode comprises a plurality of second stripe electrode areas disposed correspondingly to the first stripe electrode areas, on a same projection plane, first stripe electrode areas and second stripe electrode areas are disposed in parallel separately, and gaps between adjacent first stripe electrode areas and between adjacent second strip electrode areas are larger than or equal to 35 micro-meters (um).

According to a preferred embodiment of the present invention, first stripe electrode area and second stripe electrode area form 45° angle with optical axes of upper polarizer and lower polarizer respectively.

According to a preferred embodiment of the present invention, gaps between any two adjacent first stripe electrode areas and between any two adjacent second stripe electrode areas are the same or different.

According to a preferred embodiment of the present invention, the pixel electrode further comprises data line area, scan line area and active area, gaps between adjacent first stripe electrode areas and second stripe electrode areas corresponding to data line area and scan line area are smaller than gaps between adjacent first stripe electrode areas and second stripe electrode areas corresponding to active area; or, gaps between adjacent first stripe electrode areas and second stripe electrode areas corresponding to data line area or scan line area are smaller than gaps between adjacent first stripe electrode areas and second stripe electrode areas corresponding to active area.

The present invention provides a liquid crystal display device, which comprises: liquid crystal display panel and backlight module supplying light to the liquid crystal display panel, the liquid crystal display panel further comprises: upper substrate and lower substrate, disposed oppositely, with liquid crystal sandwiched between the upper substrate and the lower substrate; liquid crystal molecules in liquid crystal being vertically aligned; surface of upper substrate being disposed with upper polarizer, surface of lower substrate being disposed with lower polarizer, and optical axes of upper polarizer and lower polarizer being perpendicular to each other; a surface of upper polarizer closer to lower polarizer being disposed with upper quarter waveplate, a surface of lower polarizer closer to upper polarizer being disposed with lower quarter waveplate; wherein slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other.

According to a preferred embodiment of the present invention, the liquid crystal display panel is a PSVA display panel; a surface of lower quarter waveplate closer to upper quarter waveplate is disposed with pixel electrode, pixel electrode comprises a plurality of stripe electrode areas disposed in parallel separately, gap between adjacent stripe electrode areas is larger than or equal to 10 micro-meters (um).

According to a preferred embodiment of the present invention, stripe electrode area forms 45° angle with optical axis of lower polarizer.

According to a preferred embodiment of the present invention, gaps between any two adjacent stripe electrode areas are the same or different.

According to a preferred embodiment of the present invention, the pixel electrode further comprises data line area, scan line area and active area, gap between adjacent stripe electrode areas of data line area and/or scan line area is smaller than gap between adjacent stripe electrode areas of active area.

According to a preferred embodiment of the present invention, the liquid crystal display panel is a PVA display panel; a surface of upper quarter waveplate closer to lower quarter waveplate is disposed with color filter layer, a surface of lower quarter waveplate closer to upper quarter waveplate is disposed with thin film transistor layer, wherein a surface of color filter layer closer to thin film transistor layer is disposed with common electrode, a surface of thin film transistor layer closer to color filter layer is disposed with pixel electrode correspondingly; pixel electrode comprises a plurality of first stripe electrode areas disposed in parallel separately, common electrode comprises a plurality of second stripe electrode areas disposed correspondingly to the first stripe electrode areas, on a same projection plane, first stripe electrode areas and second stripe electrode areas are disposed in parallel separately, and gaps between adjacent first stripe electrode areas and between adjacent second strip electrode areas are larger than or equal to 35 micro-meters (um).

According to a preferred embodiment of the present invention, first stripe electrode area and second stripe electrode area form 45° angle with optical axes of upper polarizer and lower polarizer respectively.

According to a preferred embodiment of the present invention, gaps between any two adjacent first stripe electrode areas and between any two adjacent second stripe electrode areas are the same or different.

According to a preferred embodiment of the present invention, the pixel electrode further comprises data line area, scan line area and active area, gaps between adjacent first stripe electrode areas and second stripe electrode areas corresponding to data line area and scan line area are smaller than gaps between adjacent first stripe electrode areas and second stripe electrode areas corresponding to active area; or, gaps between adjacent first stripe electrode areas and second stripe electrode areas corresponding to data line area or scan line area are smaller than gaps between adjacent first stripe electrode areas and second stripe electrode areas corresponding to active area.

The efficacy of the present invention is that to be distinguished from the state of the art. In PSVA liquid crystal display panel, liquid crystal display panel, and liquid crystal display device of the present invention, through disposing upper quarter waveplate and lower quarter waveplate respectively on upper polarizer and lower polarizer, slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other, the incident light, after polarized by upper quarter waveplate, liquid crystal molecules and lower quarter waveplate, can emit in parallel with the original direction so as to ensure higher light transmittance as well as improve liquid crystal molecules response speed.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of pixel ITO pattern of a known PSVA liquid crystal display device;

FIG. 2 is a schematic view showing the structure of pixel ITO pattern of a known PVA liquid crystal display device;

FIG. 3 is a schematic plot showing response curve of liquid crystal molecule when supplying voltage to electrode of VA display panel;

FIG. 4 is another schematic plot showing response curve of liquid crystal molecule when supplying voltage to electrode of VA display panel;

FIG. 5 is a schematic view showing the structure of a first embodiment of the liquid crystal display panel according to the present invention;

FIG. 6 is a schematic view illustrating the relation among optical axes of upper polarizer, lower polarizer, upper quarter waveplate, lower quarter waveplate of the liquid crystal display panel of FIG. 5;

FIG. 7 is a diagram showing the operation theory of the embodiment of liquid crystal display panel of FIG. 5;

FIG. 8 is a schematic plot showing response curve of liquid crystal molecule when supplying voltage to the embodiment of liquid crystal display panel of FIG. 5;

FIG. 9 is a schematic view showing the structure of the pixel electrode of a second embodiment of the liquid crystal display panel according to the present invention;

FIG. 10 is a schematic view showing the structure of a third embodiment of the liquid crystal display panel according to the present invention; and

FIG. 11 is a schematic view showing the structure of the pixel electrode of the PVA display panel of FIG. 10.

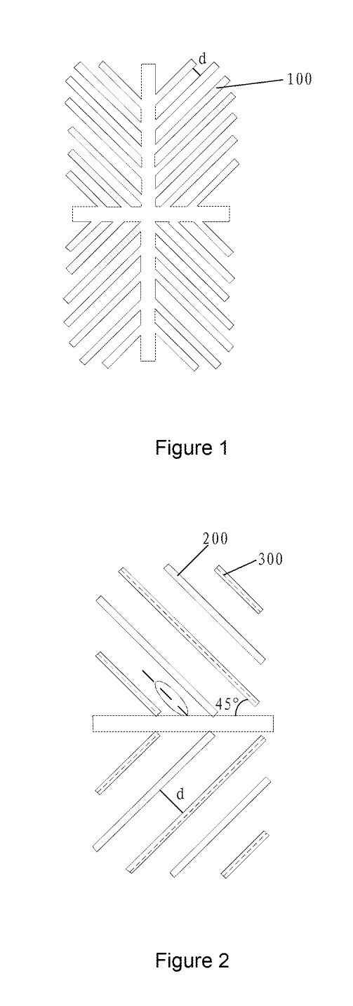

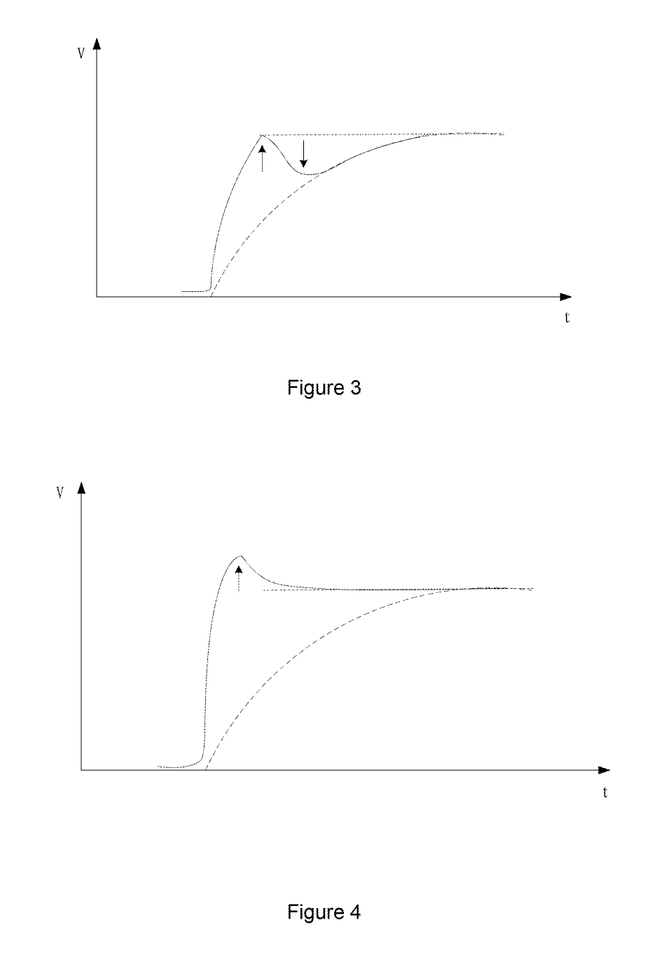

### DETAILED DESCRIPTION OF THE PREFERRED EMBODIMENTS

The following description refers to drawings and embodiments of the present invention.

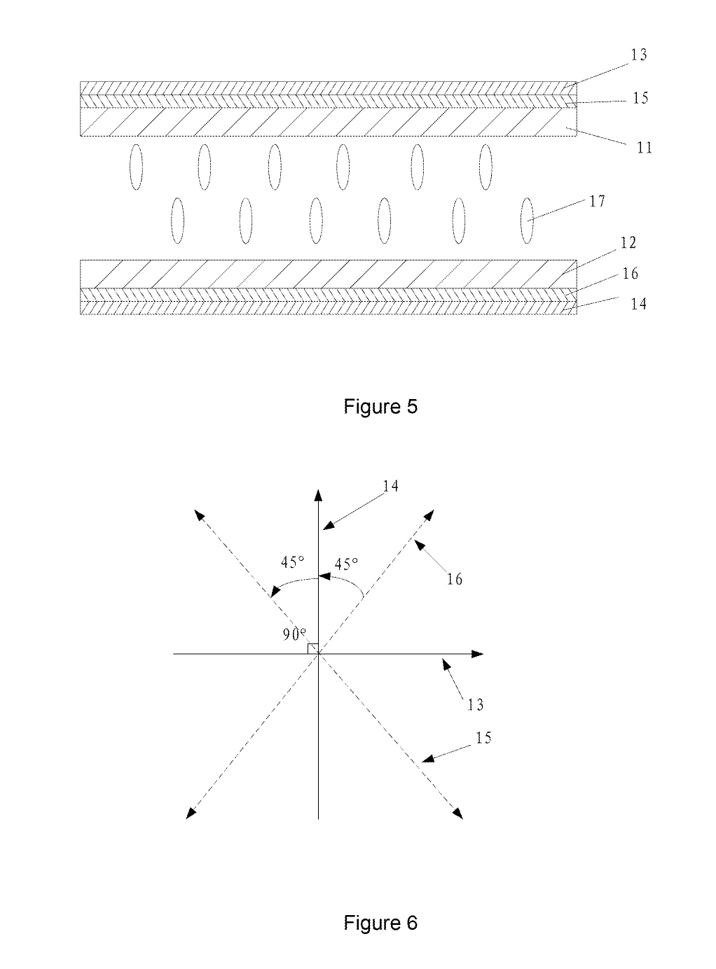

Referring to FIG. 5, FIG. 5 is a schematic view showing the structure of a first embodiment of the liquid crystal display panel according to the present invention. The first embodiment of the liquid crystal display panel according to the present invention comprises an upper substrate 11, a lower substrate 12, an upper polarizer 13, a lower polarizer 14, an upper quarter waveplate 15 and a lower quarter waveplate 16.

In the instant embodiment, upper substrate 11 and lower substrate 12 are disposed oppositely, and a liquid crystal layer comprising vertically aligned liquid crystal molecules 17 is sandwiched between upper substrate 11 and lower substrate 12; wherein liquid crystal molecule 17 is VA liquid crystal molecule. Upper polarizer 13 is disposed on a surface of upper substrate 11, and lower polarizer 14 is disposed on a surface of lower substrate 12. Optical axes of upper polarizer 13 and lower polarizer 14 are perpendicular to each other. In addition, upper quarter waveplate 15 is disposed on a surface of upper polarizer 13 closer to lower polarizer 14, and lower quarter waveplate 16 is disposed on a surface of lower polarizer 14 closer to upper polarizer 13. Upper quarter waveplate 15 and lower quarter waveplate 16 are both a waveplate with a quarter of λ phase.

It should be noted that slow axis of upper quarter waveplate 15 and slow axis of lower quarter waveplate 16 form 45° angle with optical axes of upper polarizer 13 and lower polarizer 14 respectively, and slow axis of upper quarter waveplate 15 and slow axis of lower quarter waveplate 16 are perpendicular to each other (as shown in FIG. 6).

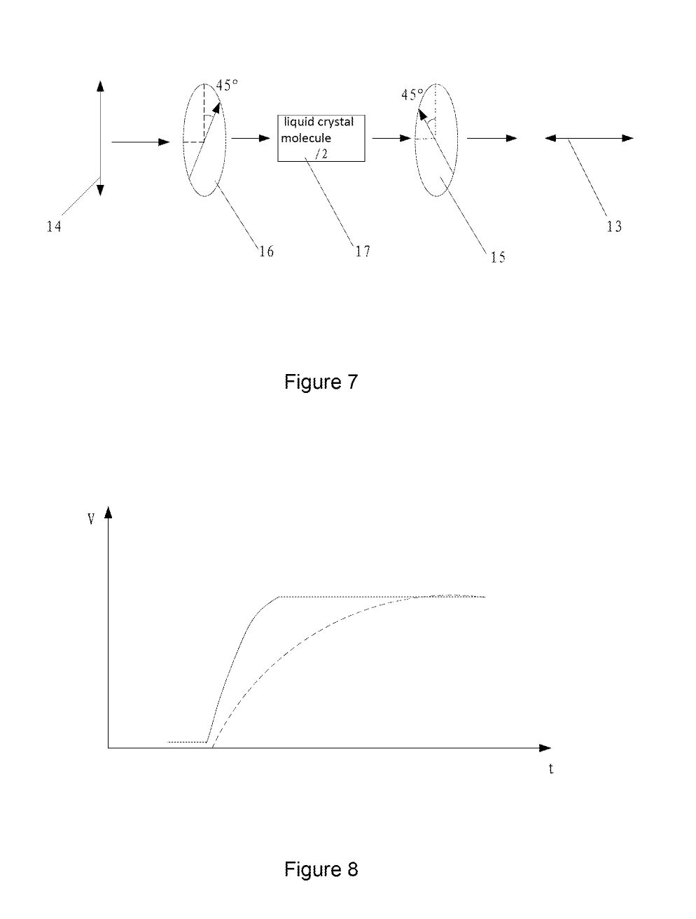

Refer to FIG. 7, the operation theory of the embodiment of the present invention is described as follows.

After light is incident to lower polarizer 14, the light becomes lower linearly polarized light due to polarization of lower polarizer 14. The lower linearly polarized light passes lower quarter waveplate 16 and becomes circularly polarized light, as shown in FIG. 7. The circularly polarized light is a left-handed circularly polarized light. The left-handed circularly polarized light then passes liquid crystal molecules 17. Although liquid crystal molecules 17 perform phase reversal on left-handed circularly polarized light to become right-handed circularly polarized light, the light remains a circularly polarized light. Then, the right-handed circularly polarized light passes upper quarter waveplate 15 and polarized by upper quarter waveplate 15 to become linearly polarized light, i.e., upper linearly polarized light with polarization direction parallel to optical axis of upper polarizer 13 to emit from upper polarizer 13. Therefore, regardless of whether liquid crystal molecules tilt to form 45° angle with optical axis of polarizer (upper polarizer 13 or lower polarizer 14), the luminance of optical performance remains the same as forming 45° angle with optical axis of polarizer. Hence, dynamic response of liquid crystal molecules 17 will not show overshooting or undershooting. Corresponding response curve of liquid crystal molecules 17 is shown in FIG. 8, and the description will not be repeated here.

Through disposing upper quarter waveplate 15 and lower quarter waveplate 16 respectively on upper polarizer 13 and lower polarizer 14, slow axis of upper quarter waveplate 15 and slow axis of lower quarter waveplate 16 forming 45° angle with optical axes of upper polarizer 13 and lower polarizer 14 respectively, and slow axis of upper quarter waveplate 15 and slow axis of lower quarter waveplate 16 being perpendicular to each other, in the instant embodiment, the incident light, after polarized by upper quarter waveplate 15, liquid crystal molecules 17 and lower quarter waveplate 16, can emit in parallel with the original direction so as to ensure higher light transmittance as well as improve liquid crystal molecules response speed.

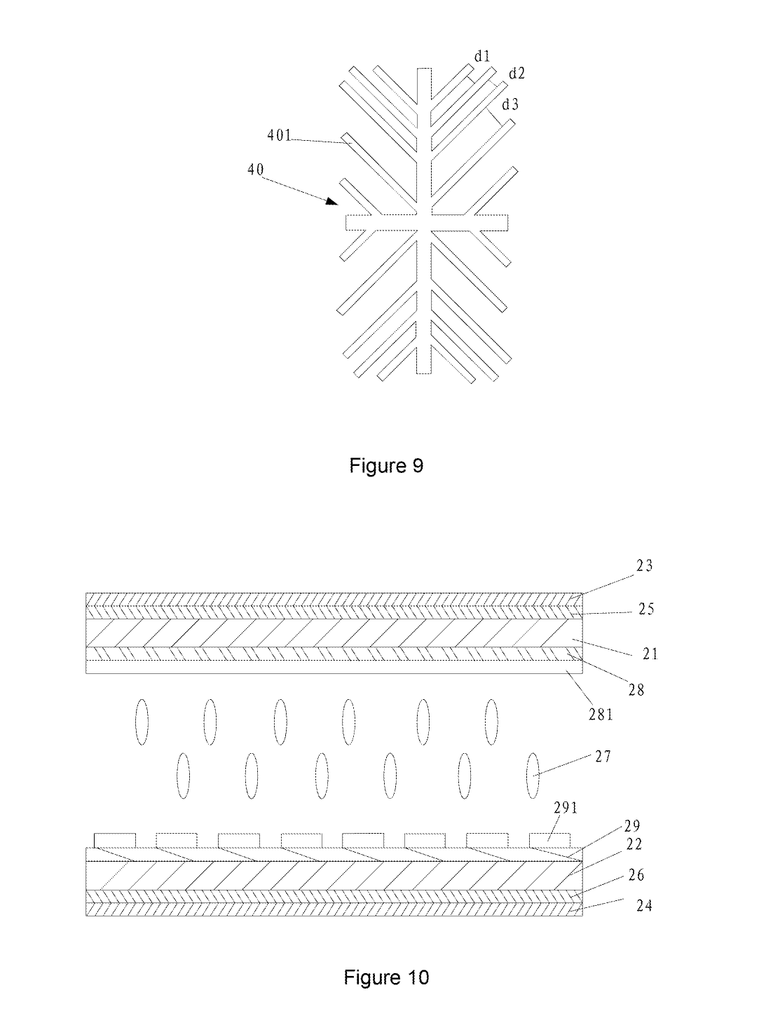

Referring to FIG. 9, FIG. 9 is a schematic view showing the structure of the pixel electrode of a second embodiment of the liquid crystal display panel according to the present invention. Also refer to FIG. 5. In the embodiment of the liquid crystal display panel of the present invention, the liquid crystal display panel is a PSVA display panel. A surface of lower quarter waveplate 16 closer to upper quarter waveplate 15 is disposed with pixel electrode 40. Pixel electrode 40 comprises a plurality of stripe electrode areas 401 disposed in parallel separately, gap between adjacent stripe electrode areas 401 is larger than or equal to 10 micro-meters (um) to ensure light transmittance. Also, stripe electrode area 401 forms 45° angle with optical axis of lower polarizer 14, with corresponding effect of: under the effect of electrical field of stripe electrode area 401, liquid crystal molecules 17 tilt to form 45° angle with optical axis of lower polarizer 14. When liquid crystal molecules 17 tilt to form 45° angle with optical axis of lower polarizer 14, the light transmittance is at maximum, i.e., to ensure higher light transmittance.

It should be noted that all gaps between adjacent stripe electrode areas 401 can have same or different width. As shown in FIG. 9, widths d1, d2, d3 of gaps between adjacent stripe electrode areas 401 can be the same or different. Take different width of gaps between adjacent stripe electrode areas 401 as example. Pixel electrode 40 comprises data line area (not shown), scan line area (not shown) on the side and active area (not shown) at the center. Gaps between adjacent stripe electrode areas 401 corresponding to data line area and/or scan line area are smaller than gaps between adjacent stripe electrode areas 401 corresponding to active area. In other words, gaps between adjacent stripe electrode areas 401 corresponding to data line area and scan line area can be disposed smaller, separately or simultaneously, than gaps between adjacent stripe electrode areas 401 corresponding to active area. Because data line area and scan line area are non-active area of pixel electrode 40, and transmittance in non-active area has little impact on displaying of liquid crystal display panel. Disposing stripe electrode areas 401 more densely in non-active area, the response speed of liquid crystal molecules 17 driven correspondingly by non-active area can be improved. The non-active area affects the response speed of liquid crystal molecules 17 driven correspondingly by entire pixel electrode 40, which results in effectively improving the response speed of liquid crystal molecules 17 driven correspondingly by entire pixel electrode 40.

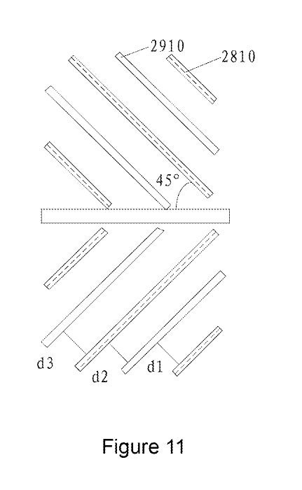

Referring to FIG. 10, FIG. 10 is a schematic view showing the structure of a third embodiment of the liquid crystal display panel according to the present invention. Also refer to FIG. 11. In this embodiment, the liquid crystal display panel is a PVA display panel. The liquid crystal display panel comprises an upper substrate 21, lower substrate 22, upper polarizer 23, lower polarizer 24, upper quarter waveplate 25 and lower quarter waveplate 26 similar to the first embodiment. Furthermore, a surface of upper substrate 21 closer to lower quarter waveplate 26 is disposed with a color filter layer 28, a surface of lower substrate 22 closer to upper quarter waveplate 25 is disposed with a thin film transistor layer 29, wherein a surface of color filter layer 28 closer to thin film transistor layer 29 is disposed with common electrode 281, a surface of thin film transistor layer 29 closer to color filter layer 28 is disposed with pixel electrode 291 correspondingly; pixel electrode 291 comprises a plurality of first stripe electrode areas 2910 disposed in parallel separately, common electrode 281 comprises a plurality of second stripe electrode 2810 areas disposed correspondingly to the first stripe electrode areas 2910. On a same projection plane, first stripe electrode areas 2910 and second stripe electrode areas 2810 are disposed in parallel separately, and gaps between adjacent first stripe electrode areas 2910 and between adjacent second strip electrode areas 2810 are larger than or equal to 35 micro-meters (um) to ensure light transmittance. In addition, first stripe electrode area 2910 and second stripe electrode area 2810 form 45° angle with optical axes of upper polarizer 21 and lower polarizer 22 respectively, with corresponding effect of: under the effect of electrical field of first stripe electrode area 2910, liquid crystal molecules 27 tilt to form 45° angle with optical axis of lower polarizer 24. (In the instant embodiment, liquid crystal molecules 27 is vertically aligned liquid crystal molecules and comprise polymer compound, i.e., liquid crystal molecules 27 is vertically aligned liquid crystal molecules with polymer compounds) When liquid crystal molecules 27 tilt to form 45° angle with optical axis of lower polarizer 24, the light transmittance is at maximum, i.e., to ensure higher light transmittance.

It should be noted that all gaps between adjacent first stripe electrode areas 2901 and second stripe electrode areas 2810 can have same or different width. As shown in FIG. 11, widths d1, d2, d3 of gaps between adjacent first stripe electrode areas 2901 and second stripe electrode areas 2810 can be the same or different. Take different width of gaps between adjacent first stripe electrode areas 2901 and second stripe electrode areas 2810 as example. Pixel electrode 291 comprises data line area (not shown), scan line area (not shown) on the side and active area (not shown) at the center. Gaps between adjacent first stripe electrode areas 2901 and second stripe electrode areas 2810 corresponding to data line area and/or scan line area are smaller than gaps between adjacent first stripe electrode areas 2901 and second stripe electrode areas 2810 corresponding to active area. Because data line area and scan line area are non-active area of pixel electrode 291, and transmittance in non-active area has little impact on displaying of liquid crystal display panel. Disposing first stripe electrode areas 2901 and second stripe electrode areas 2810 more densely in non-active area, the response speed of liquid crystal molecules 27 driven correspondingly by non-active area can be improved. The non-active area affects the response speed of liquid crystal molecules 27 driven correspondingly by entire pixel electrode 291, which results in effectively improving the response speed of liquid crystal molecules 27 driven correspondingly by entire pixel electrode 291.

Furthermore, in the present embodiment, because PVS liquid crystal display panel does not need large voltage or increase exposure time to obtain larger tilt angle of liquid crystal molecule 27, the present invention can avoid insufficient response speed, reduce the liquid crystal molecule curing time and improve yield efficiency.

In the above embodiment, the liquid crystal display panel can also be multi-domain vertical alignment (MVA) display panel.

The present invention also provides a liquid crystal display device, comprising a backlight module and any liquid crystal display panel of the above embodiments. The backlight module is to supply lighting to the liquid crystal display panel.

In the embodiment of the liquid crystal display device of the present invention, through disposing upper quarter waveplate and lower quarter waveplate respectively on upper polarizer and lower polarizer, slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other, the incident light, after polarized by upper quarter waveplate, liquid crystal molecules and lower quarter waveplate, can emit in parallel with the original direction so as to ensure higher light transmittance as well as improve liquid crystal molecules response speed.

In summary, the liquid crystal display panel and liquid crystal display device of the present invention have the advantages of:

(1) Better transmittance: because by increasing gap between electrodes, higher light transmittance can be obtained on PSVA, PVS and MVA liquid crystal display panel.

(2) Fast response speed of liquid crystal molecule: through disposing upper quarter waveplate and lower quarter waveplate on upper and lower polarizers respectively, liquid crystal molecule can maintain fast response speed.

(3) Simplified manufacture process and improved contrast: for PSVA display panel, the curing process does not need large voltage or increase exposure time to obtain larger tilt angle of liquid crystal molecule, and can avoid insufficient response speed, improve contrast of liquid crystal display panel, reduce the liquid crystal molecule curing time and improve yield efficiency

(4) Improved design freedom: allowing unequal gaps width between electrodes in pixel electrode can provide more design freedom under the circumstance of maintaining liquid crystal molecule response speed and light transmittance.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A PSVA liquid crystal display panel, which comprises:
an upper substrate and a lower substrate, disposed oppositely, with liquid crystal sandwiched between the upper substrate and the lower substrate; liquid crystal molecules in liquid crystal being vertically aligned;
a surface of the upper substrate being disposed with an upper polarizer, a surface of lower substrate being disposed with a lower polarizer, and optical axes of upper polarizer and lower polarizer being perpendicular to each other;
a surface of upper polarizer closer to lower polarizer being disposed with an upper quarter waveplate, a surface of lower polarizer closer to upper polarizer being disposed with an lower quarter waveplate;
wherein slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other;
a surface of lower quarter waveplate closer to upper quarter waveplate being disposed with pixel electrode, pixel electrode comprising a plurality of stripe electrode areas disposed in parallel separately, gap between adjacent stripe electrode areas being larger than or equal to 10 micro-meters (um); in addition, stripe electrode area forming 45° angle with optical axis of lower polarizer, gaps between any two adjacent stripe electrode areas being the same or different.

2. The PSVA liquid crystal display panel as claimed in claim 1, characterized in that:
the pixel electrode further comprises data line area, scan line area and active area, gap between adjacent stripe electrode areas of data line area and/or scan line area is smaller than gap between adjacent stripe electrode areas of active area.

3. A liquid crystal display panel, which comprises:
an upper substrate and a lower substrate, disposed oppositely, with liquid crystal sandwiched between the upper substrate and the lower substrate; liquid crystal molecules in liquid crystal being vertically aligned;
a surface of the upper substrate being disposed with an upper polarizer, a surface of the lower substrate being disposed with a lower polarizer, and optical axes of upper polarizer and lower polarizer being perpendicular to each other;
a surface of upper polarizer closer to lower polarizer being disposed with an upper quarter waveplate, a surface of lower polarizer closer to upper polarizer being disposed with a lower quarter waveplate;
wherein slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other.

4. The liquid crystal display panel as claimed in claim 3, characterized in that:
the liquid crystal display panel is a PSVA display panel; a surface of lower quarter waveplate closer to upper quarter waveplate is disposed with pixel electrode, pixel electrode comprises a plurality of stripe electrode areas disposed in parallel separately, gap between adjacent stripe electrode areas is larger than or equal to 10 micro-meters (um).

5. The liquid crystal display panel as claimed in claim 4, characterized in that:
the stripe electrode area forms 45° angle with optical axis of lower polarizer.

6. The liquid crystal display panel as claimed in claim 4, characterized in that:
gaps between any two adjacent stripe electrode areas are the same or different.

7. The liquid crystal display panel as claimed in claim 6, characterized in that:
the pixel electrode further comprises data line area, scan line area and active area, gap between adjacent stripe electrode areas of data line area and/or scan line area is smaller than gap between adjacent stripe electrode areas of active area.

8. The liquid crystal display panel as claimed in claim 3, characterized in that:
the liquid crystal display panel is a PVA display panel; a surface of upper quarter waveplate closer to lower quarter waveplate is disposed with a color filter layer, a surface of lower quarter waveplate closer to upper quarter waveplate is disposed with a thin film transistor layer, wherein a surface of color filter layer closer to thin film transistor layer is disposed with common electrode, a surface of thin film transistor layer closer to color filter layer is disposed with pixel electrode correspondingly; pixel electrode comprises a plurality of first stripe electrode areas disposed in parallel separately, common electrode comprises a plurality of second stripe electrode areas disposed correspondingly to the first stripe electrode areas; on a same projection plane, first stripe electrode areas and second stripe electrode areas are disposed in parallel separately, and gaps between adjacent first stripe electrode areas and between adjacent second strip electrode areas are larger than or equal to 35 micro-meters (um).

9. The liquid crystal display panel as claimed in claim 8, characterized in that:
the first stripe electrode area and second stripe electrode area form 45° angle with optical axes of upper polarizer and lower polarizer respectively.

10. The liquid crystal display panel as claimed in claim 9, characterized in that:
gaps between any two adjacent first stripe electrode areas and between any two adjacent second stripe electrode areas are the same or different.

11. The liquid crystal display panel as claimed in claim 10, characterized in that:
the pixel electrode further comprises data line area, scan line area and active area;
gaps between adjacent first stripe electrode areas and second stripe electrode areas corresponding to data line area and scan line area are smaller than gaps between adjacent first stripe electrode areas and second stripe electrode areas corresponding to active area;
or, gaps between adjacent first stripe electrode areas and second stripe electrode areas corresponding to data line area or scan line area are smaller than gaps between adjacent first stripe electrode areas and second stripe electrode areas corresponding to active area.

12. A liquid crystal display device, which comprises a liquid crystal display panel and a backlight module supplying lighting to the liquid crystal display panel; the liquid crystal display panel further comprises:
an upper substrate and a lower substrate, disposed oppositely, with liquid crystal sandwiched between the upper substrate and the lower substrate; liquid crystal molecules in liquid crystal being vertically aligned;
a surface of the upper substrate being disposed with an upper polarizer, a surface of the lower substrate being disposed with a lower polarizer, and optical axes of upper polarizer and lower polarizer being perpendicular to each other;
a surface of upper polarizer closer to lower polarizer being disposed with an upper quarter waveplate, a surface of lower polarizer closer to upper polarizer being disposed with a lower quarter waveplate;
wherein slow axis of upper quarter waveplate and slow axis of lower quarter waveplate forming 45° angle with optical axes of upper polarizer and lower polarizer respectively, and slow axis of upper quarter waveplate and slow axis of lower quarter waveplate being perpendicular to each other.

13. The liquid crystal display device as claimed in claim 12, characterized in that:
the liquid crystal display panel is a PSVA display panel; a surface of lower quarter waveplate closer to upper quarter waveplate is disposed with pixel electrode, pixel electrode comprises a plurality of stripe electrode areas disposed in parallel separately, gap between adjacent stripe electrode areas is larger than or equal to 10 micro-meters (um).

14. The liquid crystal display device as claimed in claim 13, characterized in that:
the stripe electrode area forms 45° angle with optical axis of lower polarizer.

15. The liquid crystal display device as claimed in claim 13, characterized in that:
gaps between any two adjacent stripe electrode areas are the same or different.

16. The liquid crystal display device as claimed in claim 15, characterized in that:
the pixel electrode further comprises data line area, scan line area and active area, gap between adjacent stripe electrode areas of data line area and/or scan line area is smaller than gap between adjacent stripe electrode areas of active area.

17. The liquid crystal display dev as cliceaimed in claim 12, characterized in that:
the liquid crystal display panel is a PVA display panel; a surface of upper quarter waveplate closer to lower quarter waveplate is disposed with a color filter layer, a surface of lower quarter waveplate closer to upper quarter waveplate is disposed with a thin film transistor layer, wherein a surface of color filter layer closer to thin film transistor layer is disposed with common electrode, a surface of thin film transistor layer closer to color filter layer is disposed with pixel electrode correspondingly; pixel electrode comprises a plurality of first stripe electrode areas disposed in parallel separately, common electrode comprises a plurality of second stripe electrode areas disposed correspondingly to the first stripe electrode areas; on a same projection plane, first stripe electrode areas and second stripe electrode areas are disposed in parallel separately, and gaps between adjacent first stripe electrode areas and between adjacent second strip electrode areas are larger than or equal to 35 micro-meters (um).

18. The liquid crystal display device as claimed in claim 17, characterized in that:
the first stripe electrode area and second stripe electrode area form 45° angle with optical axes of upper polarizer and lower polarizer respectively.

19. The liquid crystal display device as claimed in claim 17, characterized in that:
gaps between any two adjacent first stripe electrode areas and between any two adjacent second stripe electrode areas are the same or different.

20. The liquid crystal display device as claimed in claim 19, characterized in that:
the pixel electrode further comprises data line area, scan line area and active area;
gaps between adjacent first stripe electrode areas and second stripe electrode areas corresponding to data line area and scan line area are smaller than gaps between adjacent first stripe electrode areas and second stripe electrode areas corresponding to active area;
or, gaps between adjacent first stripe electrode areas and second stripe electrode areas corresponding to data line area or scan line area are smaller than gaps between adjacent first stripe electrode areas and second stripe electrode areas corresponding to active area.
